(19) United States
(12) Patent Application Publication
(10) Pub. No.: US 2017/0087962 A1
(43) Pub. Date: Mar. 30, 2017

(54) AUTOMOBILE AIR CONDITIONER

(71) Applicant: FUJI JUKOGYO KABUSHIKI KAISHA, TOKYO (JP)

(72) Inventors: Yoshinori TAMURA, Tokyo (JP); Hirotake NISHINA, TOKYO (JP); Takako MIZUNO, TOKYO (JP); Hiroaki MIKAMI, TOKYO (JP)

(21) Appl. No.: 15/280,592

(22) Filed: Sep. 29, 2016

(30) Foreign Application Priority Data
Sep. 30, 2015 (JP) 2015-193057

(51) Int. Cl. B60H 1/34; H05H 1/24; B60H 1/24

(52) U.S. Cl. CPC B60H 1/3414; B60H 1/242; H05H 1/24; B60H 2001/3471

(57) ABSTRACT

An automobile air conditioner includes a blower that is mounted on an automobile, at least one blower outlet that is open to a vehicle compartment of the automobile, a flow path that couples the blower to the at least one blower outlet, and guides an air sent from the blower to the at least one blower outlet, and at least one plasma actuator that is disposed in the flow path, and the plasma actuator is configured to generate a plasma that changes a flowing direction of the air.

### CROSS-REFERENCE TO RELATED APPLICATIONS

The present application claims priority from Japanese Patent Application No. 2015-193057 filed on Sep. 30, 2015, the entire contents of which are hereby incorporated by reference.

### BACKGROUND

1. Technical Field

The present invention relates to automobile air conditioners, and in particular, an automobile air conditioner that blows air to a vehicle compartment of an automobile from a blower outlet to make the air flow in the vehicle compartment.

2. Related Art

An automobile air conditioner that blows air to the vehicle compartment of an automobile from a blower outlet to make the air flow in the vehicle compartment has been used. The automobile air conditioner typically has a plurality of fins disposed near a blower outlet, and the direction of the air blown from the blower outlet to the vehicle compartment is adjusted by changing the angles of these fins. However, the fins cause considerable turbulence in the flow of air in some cases, unfortunately resulting in the increased sounds of the air blown from the blower outlet and the higher pressure loss.

Accordingly, as a technique of making air smoothly flow along fins, for example, Japanese Unexamined Patent Application Publication (JP-A) No. 2000-219038 has proposed an air outlet that equips a blower grille with a flow changing plate that curves toward the upstream of an air duct. This air outlet uses the flow changing plate to guide the air in the air duct to the blower grille. Accordingly, the air outlet can blow air to the vehicle compartment along the plurality of fins installed at the blower grille.

However, the air outlet described in JP-A No. 2000-219038 is unfortunately incapable of considerably preventing the fins from causing turbulence in the flow of air, which may cause the sounds of the blown air and the pressure loss.

### SUMMARY OF THE INVENTION

It is desirable to provide an automobile air conditioner that smoothly changes the direction of the air blown from a blower outlet.

An aspect of the present invention provides an automobile air conditioner including: a blower that is mounted on an automobile; at least one blower outlet that is open to a vehicle compartment of the automobile; a flow path that couples the blower to the at least one blower outlet, and guides an air sent from the blower to the at least one blower outlet; and at least one plasma actuator that is disposed in the flow path, and changes a flowing direction of the air by generating a plasma.

The at least one plasma actuator may be disposed near the at least one blower outlet, and may change the flowing direction of the air blown from the at least one blower outlet to the vehicle compartment.

The flow path may have inner wall surfaces facing each other and at least one of the inner wall surfaces has a inclined surface that is inclined in a manner that the inner wall surfaces gradually separate away from each other toward the at least one blower outlet. The at least one plasma actuator may be disposed on the inclined surface.

The automobile air conditioner may further include: a guide that is disposed near the at least one blower outlet in the flow path, the guide having outer wall surfaces facing in opposite directions, at least one of the outer wall surfaces being inclined in a manner that the outer wall surfaces gradually separate away from each other toward the at least one blower outlet. The at least one plasma actuator may be disposed on the inclined outer wall surface.

The at least one blower outlet may include a plurality of blower outlets. The flow path may couple the blower to the plurality of blower outlets. The at least one plasma actuator may allot an air flowing in the flow path to the plurality of blower outlets.

The automobile air conditioner may further include: a wind direction controller that is coupled to the at least one plasma actuator, and adjusts a power supplied to the at least one plasma actuator to control the flowing direction of the air.

### BRIEF DESCRIPTION OF THE DRAWINGS

FIG. 1 illustrates a configuration of an automobile equipped with an automobile air conditioner according to Implementation 1 of the present invention;

FIG. 2 schematically illustrates a configuration of an automobile air conditioner;

FIG. 3 illustrates a configuration of a plasma actuator;

FIG. 4 illustrates an elongated blower outlet;

FIG. 5 illustrates a rhombus-shaped blower outlet;

FIG. 6 illustrates a configuration of an automobile air conditioner according to Implementation 2;

FIG. 7 illustrates a configuration of an automobile air conditioner according to Implementation 3;

FIG. 8 illustrates a configuration of an automobile equipped with an automobile air conditioner according to Implementation 4;

FIG. 9 illustrates a configuration of an automobile air conditioner according to Implementation 4; and

FIG. 10 illustrates a configuration of an automobile air conditioner according to a modification of Implementations 1 to 4

### DETAILED DESCRIPTION

Hereinafter, preferred implementations of the present invention will be described in detail with reference to the appended drawings. Note that, in this specification and the appended drawings, structural elements that have substantially the same function and structure are denoted with the same reference numerals, and repeated description of these structural elements is omitted.

The following describes implementations of the present invention on the basis of the appended drawings.

Implementation 1

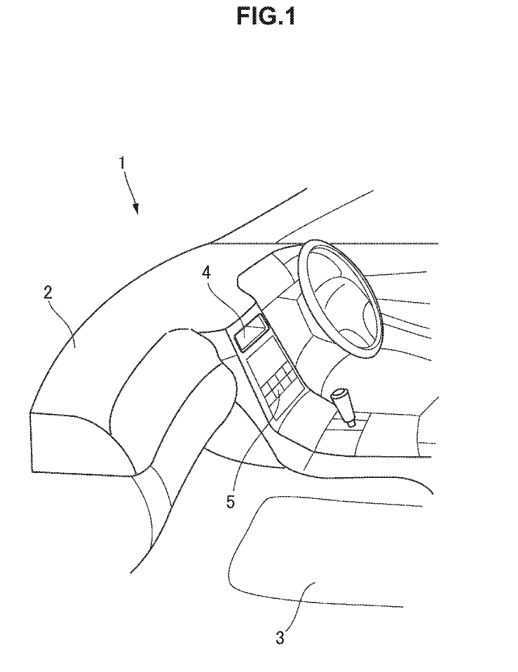

FIG. 1 illustrates the configuration of an automobile equipped with an automobile air conditioner according to Implementation 1 of the present invention. This automobile includes a windshield 1 that covers the front of the vehicle compartment, an instrument panel 2 that is disposed at the front of the vehicle compartment, a seat 3 that is disposed closer to the back of the vehicle than the instrument panel 2, a blower outlet 4 that is installed on the instrument panel 2, and an operation receiver 5 that is installed on the instrument panel 2.

The instrument panel 2 extends in the vehicle width direction, and a variety of onboard devices including the air conditioner are disposed on the instrument panel 2.

The operation receiver 5 allows a passenger of the automobile to operate the air conditioner, and is disposed in the middle of the instrument panel 2.

The blower outlet 4 is open to the vehicle compartment to blow air, and is installed to open to the back of the vehicle in the middle of the instrument panel 2.

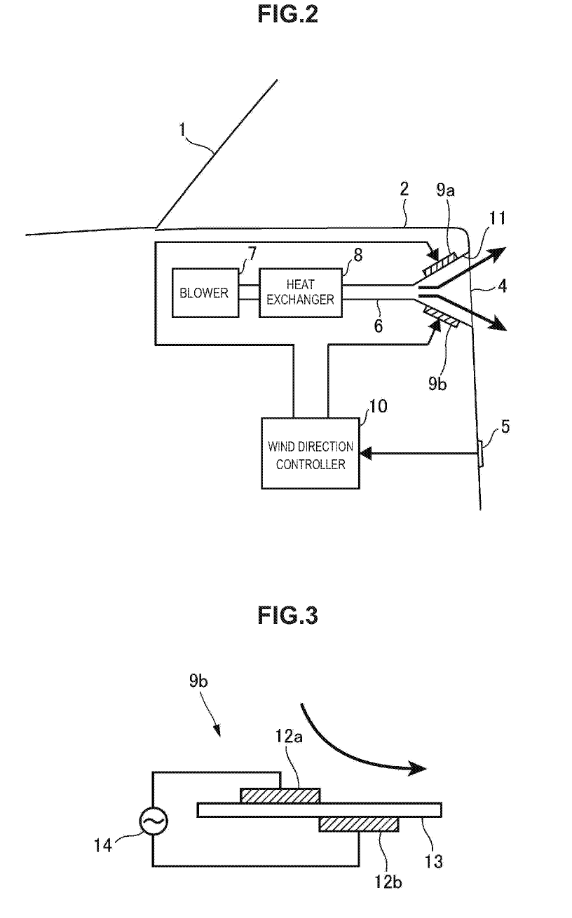

The blower outlet 4 is coupled to a blower 7 and a heat exchanger 8 via a flow path 6 as illustrated in FIG. 2. Plasma actuators 9a and 9b are disposed on the inner wall surfaces of a flow path 6, and the plasma actuators 9a and 9b and the operation receiver 5 are coupled to a wind direction controller 10.

The blower 7 communicates with the blower outlet 4 via the flow path 6, and the flow path 6 guides the air sent by the blower 7 to the blower outlet 4. The flow path 6 has inclined surfaces 11 on the inner wall surfaces facing each other in the up-down direction near the blower outlet 4, and the inclined surfaces 11 are inclined so as to gradually separate away from each other toward the blower outlet 4. In other words, the inclined surfaces 11 are upwardly and downwardly inclined to the back edge that is coupled to the blower outlet 4.

The blower 7 sends air toward the blower outlet 4, and makes the air in the flow path 6 flow toward the blower outlet 4.

The heat exchanger 8 is disposed downstream of the blower 7 in the air flow direction, and exchanges heat with the air that flows through the flow path 6. The heat exchanger 8 can cool air, for example, by depriving the air flowing through the flow path 6 of heat, and heat air by supplying heat to the air flowing through the flow path 6.

The wind direction controller 10 controls power supplied to the plasma actuators 9a and 9b, and adjusts the flowing direction of the air blown from the blower outlet 4 in accordance with an operation on the operation receiver 5.

The plasma actuators 9a and 9b changes the flowing direction of air by generating plasma. These plasma actuators 9a and 9b are disposed on the inclined surfaces 11 of the flow path 6 (i.e. near the blower outlet 4), and change the flowing direction of the air blown from the blower outlet 4 to the vehicle compartment.

Specifically, as illustrated in FIG. 3, the plasma actuators 9a and 9b each include a pair of electrodes 12a and 12b and an insulator 13 that is disposed between the electrodes 12a and 12b, and the electrodes 12a and 12b are coupled to an alternating current power supply 14. The electrodes 12a and 12b are shifted in the direction along the insulator 13. Voltage is applied to these electrodes 12a and 12b from the alternating current power supply 14, thereby causing the electrode 12a to generate plasma toward the electrode 12b and causing air to flow on the side of the electrode 12a along the insulator 13.

Next, an operation according to Implementation 1 will be described.

First of all, as illustrated in FIGS. 1 and 2, a passenger of the automobile operates the operation receiver 5 to drive the blower 7 and the heat exchanger 8. The blower 7 sends air toward the blower outlet 4 through the flow path 6, and the air has heat exchanged via the heat exchanger 8 and then is blown to the vehicle compartment from the blower outlet 4.

When the passenger would like to change the flow of the air blown from the blower outlet 4, the passenger operates the operation receiver 5 to change the flow of the air. Specifically, the wind direction controller 10 supplies power to the plasma actuators 9a and 9b, and adjusts the power in accordance with an operation on the operation receiver 5. The plasma actuators 9a and 9b are supplied with power from the alternating current power supply 14, and plasma is generated in each of the plasma actuators 9a and 9b as illustrated in FIG. 3. This upwardly and downwardly changes the flow of the air blown from the blower outlet 4.

In this way, the flow of the air blown from the blower outlet 4 is changed via the plasma actuators 9a and 9b, and there is thus nothing that blocks the flow of the air. Accordingly, it is possible to considerably reduce the sounds of the air blown from the blower outlet 4 and the pressure loss.

In addition, the plasma actuators 9a and 9b can reduce pressure loss and considerably change the flow of air. Accordingly, the blower outlet 4 can be installed at any position (i.e. wide range of installation positions). For example, even if the blower outlet 4 is disposed at the feet of a passenger (i.e. near the floor of the automobile), it is still possible to send air toward the upper body of the passenger.

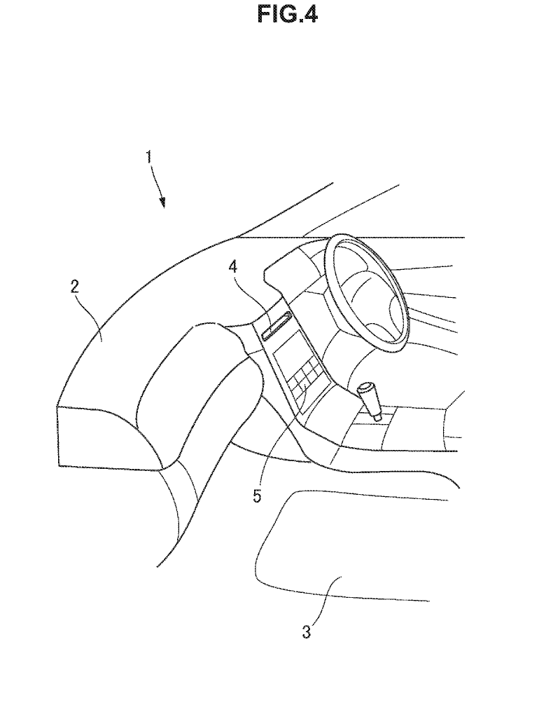

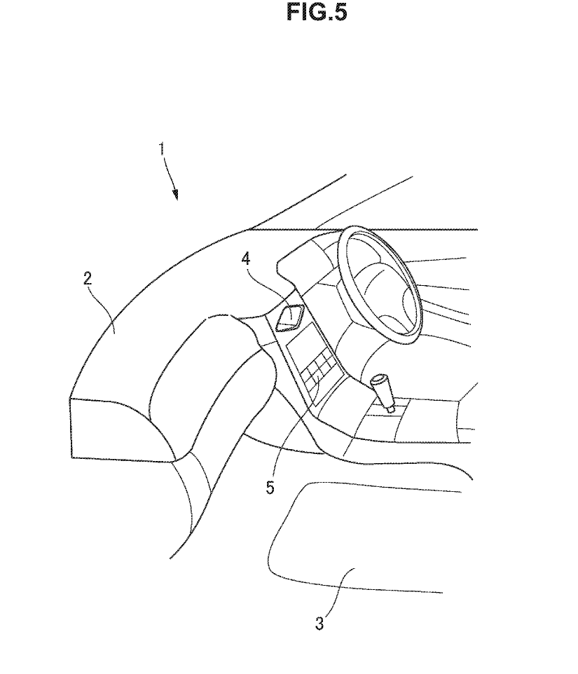

Changing the flow of air by fins in a conventional way limits the shape of the blower outlet 4 for the installation of the fins, but the plasma actuators 9a and 9b can be attached to the blower outlet 4 in a variety of shapes as long as an area large enough for the attachment is secured. Accordingly, the shape of the blower outlet 4 is not limited. For example, as illustrated in FIG. 4, the blower outlet 4 can be elongated. Meanwhile, for example, as illustrated in FIG. 5, the blower outlet 4 can be formed in a complex shape such as a rhombus.

The plasma actuators 9a and 9b are disposed on the inclined surfaces 11, which are inclined in the up-down direction in the flow path 6. It is thus possible to change the flow of air more smoothly along the inclined surfaces 11.

According to the present implementation, the plasma actuators 9a and 9b are disposed near the blower outlet 4 in the flow path 6 to change the flowing direction of air, and it is thus possible to smoothly change the direction of the air blown from the blower outlet.

Implementation 2

Although the plasma actuators 9a and 9b are disposed on the inner wall surfaces of the flow path 6 in Implementation 1, the plasma actuators 9a and 9b do not necessarily have be disposed on the inner wall surfaces of the flow path 6 as long as the plasma actuators 9a and 9b are disposed in the flow path 6 and the flowing direction of air can be changed.

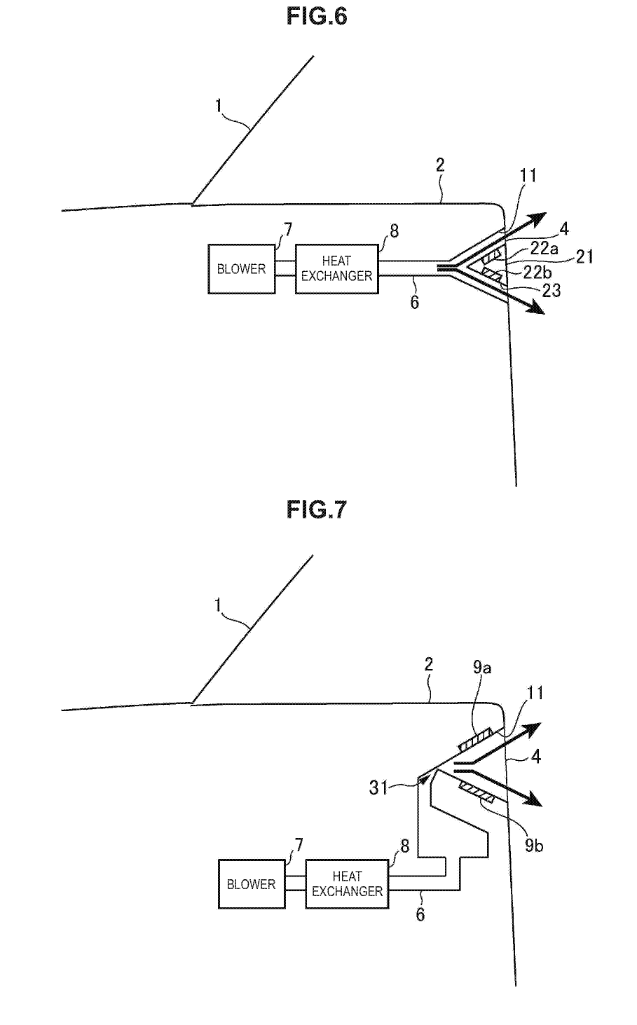

For example, as illustrated in FIG. 6, it is possible in Implementation 2 to newly dispose a guide 21 and to dispose plasma actuators 22a and 22b instead of the plasma actuators 9a and 9b.

The guide 21 is disposed near the blower outlet 4 in the flow path 6. The guide 21 extends in the middle of the flow path 6 in the vehicle width direction, and has both ends fixed to the inner wall surfaces of the flow path 6. The guide 21 has inclined surfaces 23 that are inclined in a manner that the outer wall surfaces facing upward and downward gradually separate away from each other toward the blower outlet 4.

The plasma actuators 22a and 22b are disposed on the inclined surfaces 23 of the guide 21.

Similarly to Implementation 1, the plasma actuators 22a and 22b are supplied with power, thereby generating plasma and upwardly and downwardly changing the flow of the air blown from the blower outlet 4. The plasma actuators 22a and 22b are disposed on the inclined surfaces 23, which are inclined in the up-down direction in the guide 21. It is thus possible to change the flow of air more smoothly along the inclined surfaces 23.

According to the present implementation, the plasma actuators 22a and 22b are disposed in the opposite direction to the blower outlet 4 along the inclined surfaces 23 of the guide 21 (i.e. the plasma actuators 22a and 22b are disposed to face the front of the vehicle), and it is thus possible to prevent a passenger of the automobile from coming into contact with the plasma actuators 22a and 22b.

Implementation 3

In Implementations 1 and 2, it is possible to shape the area of the flow path 6 near the blower outlet 4 like a narrow slit.

For example, as illustrated in FIG. 7, it is possible in Implementation 3 to form a slit 31 in the flow path 6. This slit 31 is disposed near the backs of the plasma actuators 9a and 9b in the flow path 6. The flow of air toward the blower outlet 4 via the slit 31 is changed by the plasma actuators 9a and 9b.

In this way, the plasma actuators 9a and 9b can be attached to the flow path 6 in a variety of shapes.

According to the present implementation, the installation of the slit 31 in the flow path 6 can prevent a foreign object from entering the flow path 6 via the blower outlet 4, and the air conditioner can be safely driven. In addition, the back of the flow path 6 is not exposed via the blower outlet 4, and it is thus possible to improve the appearance of the flow path 6 and the blower outlet 4

Implementation 4

Although plasma actuators are disposed near the blower outlet 4 in the flow path 6 in Implementations 1 to 3, plasma actuators do not necessarily have to be disposed near the blower outlet 4 as long as plasma actuators are disposed in the flow path 6 and can change the flowing direction of air by generating plasma.

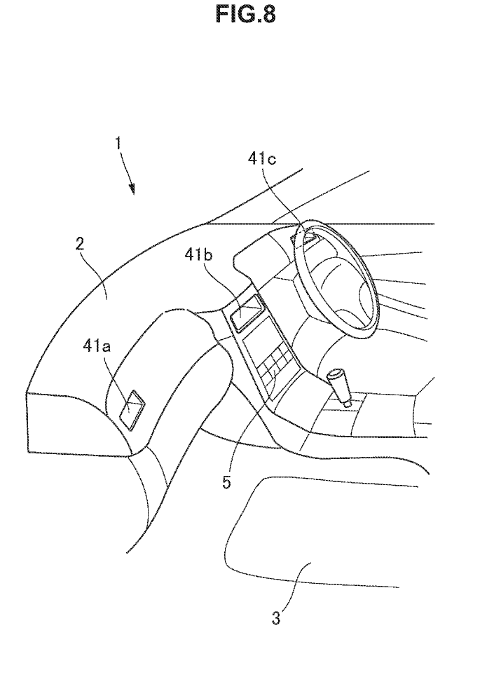

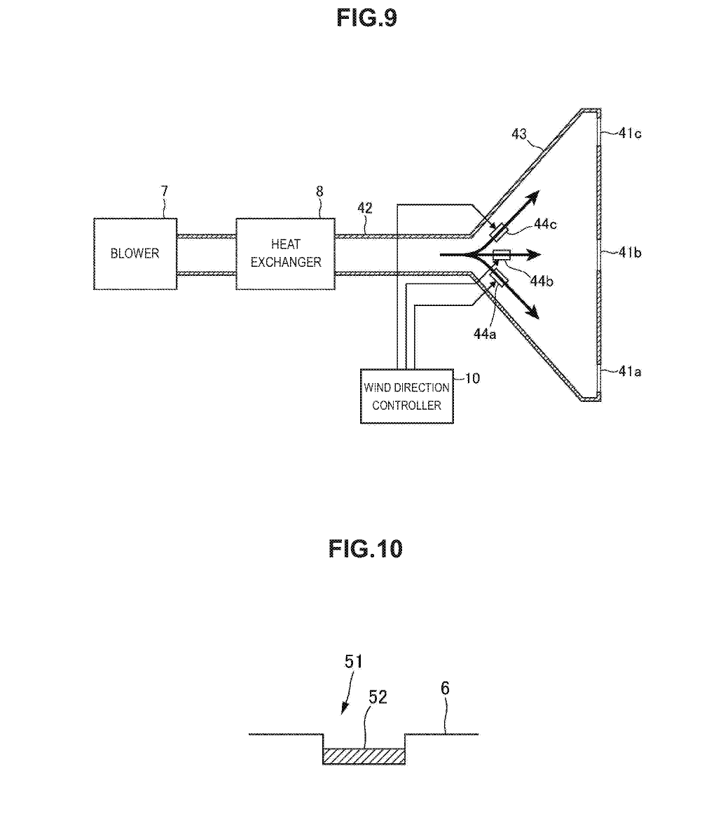

For example, as illustrated in FIG. 8, it is possible to dispose three blower outlets 41a, 41b, and 41c arranged in the vehicle width direction on the instrument panel 2 instead of the blower outlet 4 according to Implementation 1. As illustrated in FIG. 9, these blower outlets 41a, 41b, and 41c are coupled to the blower 7 and the heat exchanger 8 by a flow path 42. The flow path 42 has an expansion section 43 that expands in the vehicle width direction in the place where the flow path 42 is coupled to the blower outlets 41a, 41b, and 41c. The expansion section 43 collectively couples the blower outlets 41a, 41b, and 41c (i.e. the expansion section 43 communicates with all of the blower outlets 41a, 41b, and 41c).

There are plasma actuators 44a, 44b, and 44c disposed at the back of the expansion section 43 for the blower outlets 41a, 41b, and 41c. These plasma actuators 44a, 44b, and 44c are coupled to the wind direction controller 10, and the wind direction controller 10 controls power supplied to the plasma actuators 44a, 44b, and 44c to switch the flows of air toward the blower outlets 41a, 41b, and 41c.

In other words, the plasma actuators 44a, 44b, and 44c changes the direction of the air flowing into the expansion section 43 to allot the air to the blower outlets 41a, 41b, and 41c under the control of the wind direction controller 10.

The wind direction controller 10 can then adjust the amounts of air blown from the blower outlets 41a, 41b, and 41c via power supplied to the plasma actuators 44a, 44b, and 44c. For example, the wind direction controller 10 can increase the amounts of air blown from the blower outlets 41b and 41c as compared with the amount of air blown from the blower outlet 41a. In addition, it is possible to drive the plasma actuator 44a alone for blowing air from the blower outlet 41a, while substantially closing the blower outlets 41b and 41c for blowing no air.

According to the present implementation, the expansion section 43 is installed in the flow path 42, and the plasma actuators 44a, 44b, and 44c change the flow of air. Accordingly, even if the plurality of blower outlets 41a, 41b, and 41c are installed, there is no need to dispose different flow paths that extend to the respective blower outlets 41a, 41b, and 41c, and it is then possible to collectively couple the plurality of blower outlets 41a, 41b, and 41c. It is thus possible to couple the blower outlet 41a, 41b, and 41c to the flow path 42 with ease.

Additionally, it is preferable to dispose a plasma actuator in a concave section formed in the flow path in Implementations 1 to 4. For example, as illustrated in FIG. 10, it is possible to form a concave section 51 on an inner wall surface of the flow path 6, and to dispose a plasma actuator 52 in this concave section 51. It is desirable to cover the surface of the plasma actuator 52, for example, with a porous material in order to avoid electrical influence.

Although a plasma actuator is disposed to face upward or downward in Implementations 1 to 4, the disposition of a plasma actuator is not limited thereto as long as it is possible to change the flowing direction of air. For example, a plasma actuator can be disposed to face sideward. There is no need to dispose a plurality of plasma actuators, and it is also possible to dispose a single plasma actuator.

Although the wind direction controller 10 is coupled to the operation receiver 5 and operated by a passenger of the automobile in Implementations 1 to 4, a plasma actuator may also be automatically controlled. For example, a thermometer is disposed in the vehicle compartment, and the wind direction controller 10 can automatically control a plasma actuator on the basis the temperature indicated by this thermometer. This makes it possible to efficiently condition the air in the vehicle compartment, and to drive the air conditioner with less energy.

Although the preferred implementations of the present invention have been described in detail with reference to the appended drawings, the present invention is not limited thereto. It is obvious to those skilled in the art that various modifications or variations are possible insofar as they are within the technical scope of the appended claims or the equivalents thereof. It should be understood that such modifications or variations are also within the technical scope of the present invention.

1. An automobile air conditioner, comprising:
a blower that is mounted on an automobile;
at least one blower outlet that is open to a vehicle compartment of the automobile;
a flow path that couples the blower to the at least one blower outlet, and guides an air sent from the blower to the at least one blower outlet; and
at least one plasma actuator that is disposed in the flow path, and the at least one plasma actuator is configured to generate a plasma that changes a flowing direction of the air.

2. The automobile air conditioner according to claim 1,
wherein the at least one plasma actuator is disposed near the at least one blower outlet, and changes the flowing direction of the air blown from the at least one blower outlet to the vehicle compartment.

3. The automobile air conditioner according to claim 2,
wherein the flow path has inner wall surfaces that face each other and at least one of the inner wall surfaces has an inclined surface that is inclined in a manner that the inner wall surfaces gradually separate away from each other toward the at least one blower outlet, and
wherein the at least one plasma actuator is disposed on the inclined surface.

4. The automobile air conditioner according to claim 2, further comprising:
a guide that is disposed near the at least one blower outlet in the flow path, the guide having outer wall surfaces that face in opposite directions, at least one of the outer wall surfaces is inclined in a manner that the outer wall surfaces gradually separate away from each other toward the at least one blower outlet,
wherein the at least one plasma actuator is disposed on the inclined outer wall surface.

5. The automobile air conditioner according to claim 3, further comprising:
a guide that is disposed near the at least one blower outlet in the flow path, the guide has outer wall surfaces facing in opposite directions, at least one of the outer wall surfaces is inclined in a manner that the outer wall surfaces gradually separate away from each other toward the at least one blower outlet,
wherein the at least one plasma actuator is disposed on the inclined outer wall surface.

6. The automobile air conditioner according to claim 1,
wherein the at least one blower outlet includes a plurality of blower outlets,
wherein the flow path couples the blower to the plurality of blower outlets, and
wherein the at least one plasma actuator allots an air that flows in the flow path to the plurality of blower outlets.

7. The automobile air conditioner according to claim 2,
wherein the at least one blower outlet includes a plurality of blower outlets,
wherein the flow path couples the blower to the plurality of blower outlets, and
wherein the at least one plasma actuator allots an air that flows in the flow path to the plurality of blower outlets.

8. The automobile air conditioner according to claim 3,
wherein the at least one blower outlet includes a plurality of blower outlets,
wherein the flow path couples the blower to the plurality of blower outlets, and
wherein the at least one plasma actuator allots an air flowing in the flow path to the plurality of blower outlets.

9. The automobile air conditioner according to claim 4,
wherein the at least one blower outlet includes a plurality of blower outlets,
wherein the flow path couples the blower to the plurality of blower outlets, and
wherein the at least one plasma actuator allots an air that flows in the flow path to the plurality of blower outlets.

10. The automobile air conditioner according to claim 5,
wherein the at least one blower outlet includes a plurality of blower outlets,
wherein the flow path couples the blower to the plurality of blower outlets, and
wherein the at least one plasma actuator allots an air that flows in the flow path to the plurality of blower outlets.

11. The automobile air conditioner according to claim 1, further comprising:
a wind direction controller that is coupled to the at least one plasma actuator, and adjusts a power supplied to the at least one plasma actuator to control the flowing direction of the air.

12. The automobile air conditioner according to claim 2, further comprising:
a wind direction controller that is coupled to the at least one plasma actuator, and adjusts a power supplied to the at least one plasma actuator to control the flowing direction of the air.

13. The automobile air conditioner according to claim 3, further comprising:
a wind direction controller that is coupled to the at least one plasma actuator, and adjusts a power supplied to the at least one plasma actuator to control the flowing direction of the air.

14. The automobile air conditioner according to claim 4, further comprising:
a wind direction controller that is coupled to the at least one plasma actuator, and adjusts a power supplied to the at least one plasma actuator to control the flowing direction of the air.

15. The automobile air conditioner according to claim 5, further comprising:
a wind direction controller that is coupled to the at least one plasma actuator, and adjusts a power supplied to the at least one plasma actuator to control the flowing direction of the air.
